(19) United States
(12) Patent Application Publication
(10) Pub. No.: US 2008/0092544 A1
(43) Pub. Date: Apr. 24, 2008

(54) Premixer for gas and fuel for use in combination with energy release/conversion device

(75) Inventor: Anatoly M. Rakhmailov, Cincinnati, OH (US)

Correspondence Address: HUGHES HUBBARD & REED LLP, ONE BATTERY PARK PLAZA, NEW YORK, NY, 10004, US

(73) Assignee: LEAN FLAME, INC.

(21) Appl. No.: 11/874,297

(22) Filed: Oct. 18, 2007

Related U.S. Application Data
(60) Provisional application No. 60/829,993, filed on Oct. 18, 2006.

(51) Int. Cl. F02C 1/00

(52) U.S. Cl. 60/737

(57) ABSTRACT

The invention relates to the use of a premixing apparatus for gas and fuel in combination with energy release/conversion device of a type characterized by having a high intake velocity.

### CROSS-REFERENCE TO RELATED APPLICATION

This application claims the benefit of the filing date of my U.S. Provisional Patent Application Ser. No. 60/829,993, titled “Premixer that mixes both gas and liquid fuel,” filed Oct. 18, 2006, the entire disclosure of which is hereby incorporated by reference.

### FIELD OF THE INVENTION

The invention relates to the field of combustion, and concerns a premixer for use in connection with a combustor, burner, furnace or other energy conversion device.

### BACKGROUND OF THE RELATED ART

Flexibility in fuel selection has long been a design objective (or a desired but unavailable feature) for energy release/conversion systems, such as combustors, burners, furnaces and the like. (As will be more fully described in the detailed description, the term “energy release/conversion system” generally means any combustor, burner, furnace or other energy conversion device.)

Present day continuous (as opposed to reciprocating) energy release/conversion systems were in large part derived from early jet engine design. Because of this lineage, aviation fuels such as kerosene have always been burned in gas turbines. As the power generation and aviation applications diverged and specialized, land-based turbines began to bum primarily natural gas fuels. While fuel flexibility (the ability to use a variety of liquid and gaseous fuels) remains desirable for economic and operational reasons, land-based power generating and mechanical drive turbines have been fitted with specialized combustors capable of burning only natural gas (primarily methane) fuels. These specialized combustors are sometimes combined with liquid fuel combustion systems (however, with different fuel nozzles and mixing hardware) in the same overall turbine. Such machines can bum gas fuel in premixed mode thus complying with emissions regulations but occasionally burn liquid fuels in diffusion mode. Some attempts have been made to do premixing of liquid fuels in what are known as DLE combustors but these are typically optimized for liquid only.

With respect to combustors, the general classes are diffusion, premixed, diffusion with diluents and hybrid systems. The most flexible installations in use today are “tri-fuel” diluents injected systems. Tri-fuel refers to gas, distillate, crude. It is well known that gas fuels are easily burned in premixed combustors with satisfactory emissions. However, hardware that can premix liquid fuels in swirl stabilized systems has not been practical, at least not the same hardware. Therefore, a tri-fuel machine will have breach or otherwise parallel plumbing to deliver liquid fuels.

In all such practical circumstances the combusting on liquids in a multi-fuel system is in a diffusion mode. When burning liquids in diffusion mode the NOx emissions are very high, so often water or steam is injected (either concentric/breach with the liquid fuel, premixed almost as an emulsion, or from the side through the wrapper) to quench the core of the diffusion flame, reducing NOx somewhat.

The third fuel, in some installations, is crude. High paraffin content makes crude too viscous to pump at ambient temperatures and so most systems that burn crude need to start and stop and distillate to “clean” the lines. Once the machine is operating, the crude can be preheated and flows. As mentioned earlier, while premixed liquid systems have been attempted, the tuning of the holes and swirlers is optimized for a particular fuel and is difficult to for crude at all, and may be impossible to accomplish in the same hardware a for distillate. Thus the tri-fuel systems will burn the preheated crude in diffusion mode with high emissions and often have the need for diluents injection.

Accordingly, it is extremely desirable to develop an energy release/conversion system capable of burning a wide variety of fuels, using substantially the same hardware regardless of the type of fuel, thereby allowing a gas turbine (for example) to change fuels opportunistically while still achieving the desired operating characteristics, such as generating very low emissions.

### SUMMARY OF THE INVENTION

The invention herein disclosed takes advantage of the high intake velocities present in some ERCs (such as, for example, the apparatus described in U.S. Pat. No. 7,086,854 B1, hereinafter referred to as the “Lean Flame Combustor”) to make a multi-fuel system accomplishing low emissions with a wide array of fuels combusted in a premixed mode. The system preferably includes additional system and component features enabling further exploitation of the basic apparatus disclosed.

### DETAILED DESCRIPTION

The following is a detailed description of certain embodiments of the invention. Note however, that the invention is not limited to the embodiments specifically described.

As used herein, the term “energy release/conversion system” (or “ERC”) means any combustor, furnace, reactor, burner or the like wherein fuel is burned or reacted, including without limitation the combustor or burner for any Brayton cycle device (such as gas turbine power generator, gas turbine mechanical drive, jet engine, gas turbine, marine or land propulsion device), or for any boiler, furnace or like apparatus. Unless otherwise specified, it is assumed that any energy conversion portion of such apparatus is continuously operating (as opposed to reciprocating).

One example of an ERC is the Lean Flame Combustor. In summary, a Lean Flame Combustor may be understood as a combustor which substantially premixes fuel and air before entering the combustion geometry, and whose geometry creates aerodynamic recirculation primarily axial (to be distinguished from swirl or diffusion stabilized flame), resulting in flame stabilization.

The presence of relatively high intake velocities in an ERC makes it feasible to have robust and effective premixing of fuel and air before the mixture enters the heat-releasing zone of the ERC.

ERCs such as the Lean Flame Combustor operate at sufficiently high gas velocities that “flashback” and coking can be substantially avoided in relevant operating conditions. As a result, fuels can be safely and effectively premixed with most or all of the compressed air (in gas turbines) (combustion and dilution air in standalone burners) before entering the burning apparatus (where the heat is released), without concern for coking or flashback.

The ability to perform premixing introduces possibilities for operating the ERC with a selection of fuels.

Fuels of interest include but are not limited to: natural gas (primarily methane), propane, LNG, ethanol, methanol, higher alcohols, gasoline, distillates (kerosene, diesel, aviation fuels), crude oil, tar, bunker c, syngas (from coal, pet coke, process gasses etc.), and entrained pulverized solids (PC). Such burning is desirable in continuous cycles including but not limited to gas turbine power generation, gas turbine mechanical drives, gas turbine aviation, land and marine propulsion, burners for boilers and furnaces for power generation, steam generation and a wide variety of industrial processes. The applications covered by this invention include all of the above.

In one embodiment, fuel and oxidant are substantially premixed in an apparatus (akin to a carburetor but for continuous cycles) separate from the heat release region of an ERC continuous energy release/conversion system. Such an embodiment is hereinafter referred to as “separately premixed energy converter”.

An additional element to such an apparatus may optionally be a manifold injecting fuel through one or a plurality of orifices into a duct or pipe containing most or all of the air such that turbulent or diffusional mixing occur before entry into the heat release region.

The separately premixed energy converter may also be preceded by a fuel pre-heater, such pre-heater being a heat exchanger recovering heat from the combustion process, hot compressor air, electrically or separately combustion heated, such exchanger being liquid liquid, liquid gas or gas gas or using and intermediary heat transfer fluid, such heat exchanger being tube and shell, plate fin, tub fin or hybrid, and such preheating to allow lower viscosity of fuel for easier pumping or atomizing or evaporation; to enhance reaction characteristics such as light of lean blow out, emissions or dynamics; and to enhance system efficiency, optimize size or operability; and/or any combination of the above.

In another configuration, the separately premixed energy converter may include chemical fuel pre-treatment including but not limited to—treatment to remove sulfur (e.g. steam hydrogen sulfide reactor) where any endothermic reactions receive heat from heat rejected elsewhere in the system, where the endothermic heat required is provided directly from combustion of the main fuel, of an auxiliary fuel or electrically, treatment to remove vanadium (e.g., magnesium exchange) treatment to add or modify lubricity, treatment to modify viscosity, addition of water, blending of fuels including but not limited to hydrogen addition.

In a further configuration, the separately premixed energy converter may include physical fuel pre-treatment including but not limited to—separation of higher hydrocarbons (e.g., by cyclonic separation of condensed phases), pulverization, entrainment in a two phase flow (e.g., coal dust in air).

In another embodiment, the separately premixed energy converter may include switching devices that change fuels during operation, for example but not limited to an actuator changing the fuel source for delivery through the same orifice(s), through separate orifice(s) dedicated to a subset of the available fuels, delivering a mixture of fuels, while heat release continues. As a further example, such change capability may provide for the use of highly viscous fuel (crude) by starting and stopping with gas or distillate or any lower viscosity fuel to prevent obstruction plumbing or for any other operationally relevant reason.

Furthermore, the invention may be practiced, without a separate “premixer” per se, in an ERC having a recirculation zone (such as the Lean Flame Combustor), where the fuel and oxidant are substantially premixed in the recirculation zone.

Other possible alternatives and embodiments for the invention will be apparent to those skilled in the art, from the above descriptions.

It is evident that the embodiments described herein accomplish the stated objects of the invention. While the presently preferred embodiments have been described in detail, it will be apparent to those skilled in the art that the principles of the invention are realizable by other devices, systems and methods without departing from the scope and spirit of the invention, as defined in the following claims.

I claim:

1. In a continuously operating energy release/conversion system, wherein energy is released from fluids comprising fuel and air, wherein said fluids pass in major portion along a main flow path and in a lesser portion through a recirculation zone, the flow from said recirculation zone rejoining said main flow path at a return point proximate the inlet of said main flow path, said recirculation flow flowing along the interior surface of said recirculation zone, said interior surface being characterized by a lack of discontinuities, and said recirculation flow moving in substantially the same direction as said main flow after said recirculation flow exits said recirculation zone and after said main flow passes said return point, resulting in a high intake velocity in said energy release/conversion system,
the combination of the structure defining the opening of said inlet of said main flow path with a fuel/air premixing apparatus separate from the beat release region of said energy release/conversion system.

2. The apparatus of claim 1 wherein said premixing apparatus comprises a manifold injecting fuel through one or a plurality of orifices into a duct or pipe containing most or all of the combustion air flowing into said energy release/conversion device such that turbulent or diffusional mixing occur before entry into the heat release region of said energy release/conversion system.

3. The apparatus of claim 1 further comprising a pre-heater for the fuel to be introduced into said premixing apparatus.

4. The apparatus of claim 3 wherein said pre-heater is a heat exchanger.

5. The apparatus of claim 4 wherein said heat exchanger draws heat from one or more sources drawn from the group of heat sources comprising the combustion process, hot compressor air, electric heat or heat from separate combustion.

6. The apparatus of claim 4 wherein said heat exchanger is of a type selected from the group consisting of liquid-liquid, liquid-gas or gas-gas or using and intermediary heat transfer fluid.

7. The apparatus of claim 1 further comprising a chemical fuel treatment apparatus.

8. The apparatus of claim 7 wherein said chemical fuel treatment apparatus is provided endothermic heat from a source selected from one or more of the group consisting of combustion of the main fuel, combustion of an auxiliary fuel, or electrical heating.
